(19) United States
(12) Patent Application Publication
(10) Pub. No.: US 2025/0274011 A1
(43) Pub. Date: Aug. 28, 2025

(54) POWER TOOL MOTOR INCLUDING HEAT DISSIPATING FEATURES

(71) Applicant: MILWAUKEE ELECTRIC TOOL CORPORATION, Brookfield, WI (US)

(72) Inventors: John L. O'Sullivan, Milwaukee, WI (US); Rishit Arora, Brookfield, WI (US)

(21) Appl. No.: 19/064,078

(22) Filed: Feb. 26, 2025

Related U.S. Application Data
(60) Provisional application No. 63/557,773, filed on Feb. 26, 2024.

(51) Int. Cl. H02K 7/14; H02K 1/20; H02K 3/30

(52) U.S. Cl. CPC H02K 7/145; H02K 1/20; H02K 3/30

(57) ABSTRACT

A power tool including a housing and a motor assembly positioned within the housing. The motor assembly includes a rotor and a stator. The stator includes a plurality of stator windings, an end cap, and an insulative portion. The insulative portion has an in-plane thermal conductivity of at least 2.0 Watts per meter-kelvin (“W/mK”).

### RELATED APPLICATIONS

This application claims the benefit of U.S. Provisional Patent Application No. 63/557,773, filed Feb. 26, 2024, the entire content of which is hereby incorporated by reference.

### FIELD

This disclosure relates to power tools.

### SUMMARY

Embodiments described herein relate to a motor of a power tool including a motor having a plurality of heat dissipating features.

Power tools described herein include a housing and a motor assembly positioned within the housing. The motor assembly includes a rotor and a stator. The stator includes a plurality of stator windings, an end cap, and an insulative portion. The insulative portion has an in-plane thermal conductivity of at least 2.0 Watts per meter-kelvin (“W/mK”).

Power tools described herein include a housing and a motor assembly positioned within the housing. The motor assembly includes a rotor and a stator. The stator includes a plurality of stator windings and a stator lamination including at least one fin extending radially outwardly from a center of the stator lamination.

Power tools described herein include a housing and a motor assembly positioned within the housing. The motor assembly includes a rotor and a stator. The stator includes a plurality of finned regions spaced circumferentially from each other around a circumference of the stator. Each finned region includes a plurality of fins extending radially outwardly from an outer surface of the stator.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

### BRIEF DESCRIPTION OF THE DRAWINGS

FIG. 1 illustrates a perspective view of a power tool, according to some embodiments.

FIG. 2 illustrates a block diagram of a control system of the power tool of FIG. 1, according to some embodiments.

FIG. 3 illustrates a battery pack for use with the power tool of FIG. 1, according to some embodiments.

FIG. 4 illustrates a block diagram of a control system of the battery pack of FIG. 3, according to some embodiments.

FIG. 5 illustrates a side view of a motor, according to some embodiments.

FIG. 6 illustrates a top view of a stator lamination, according to some embodiments.

FIG. 7 illustrates a perspective view of a stator of a motor, according to some embodiments.

FIG. 8 illustrates a top view of the stator of FIG. 7.

FIG. 9 illustrates an internal view of a power tool housing, according to some embodiments.

FIG. 10 illustrates an internal view of a power tool housing, according to some embodiments.

FIG. 11 illustrates an internal view of a power tool housing, according to some embodiments.

FIG. 12A illustrates a perspective view of a stator of a motor, according to some embodiments.

FIG. 12B illustrates another perspective view of the stator of the motor of FIG. 12A.

FIG. 12C illustrates another perspective view of the stator of the motor of FIG. 12A.

### DETAILED DESCRIPTION

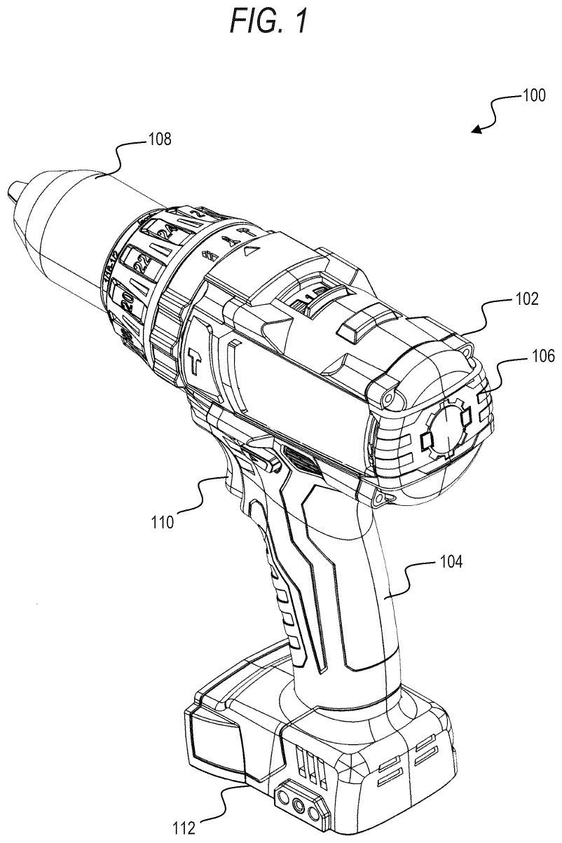

FIG. 1 illustrates a power tool 100 including a motor. The power tool 100 is, for example, a hammer drill including a housing 102. Although FIG. 1 illustrates a hammer drill, in some embodiments, the components described herein are incorporated into other types of power tools including drill-drivers, impact drivers, impact wrenches, angle grinders, circular saws, reciprocating saws, plate compactors, core drills, string trimmers, leaf blowers, vacuums, or other applicable applications. The housing 102 includes a handle portion 104 and motor housing portion 106. The motor or motor assembly is positioned within the motor housing portion 106. The power tool 100 further includes an output driver 108 (illustrated as a chuck), a trigger 110, and a battery pack interface 112. The battery pack interface 112 is configured to mechanically and electrically connect to or receive a power tool battery pack. In a power tool such as power tool 100, switching elements are selectively enabled and disabled by control signals from a controller (or gate driver) to selectively apply power from a power source (e.g., a battery pack) to drive the motor.

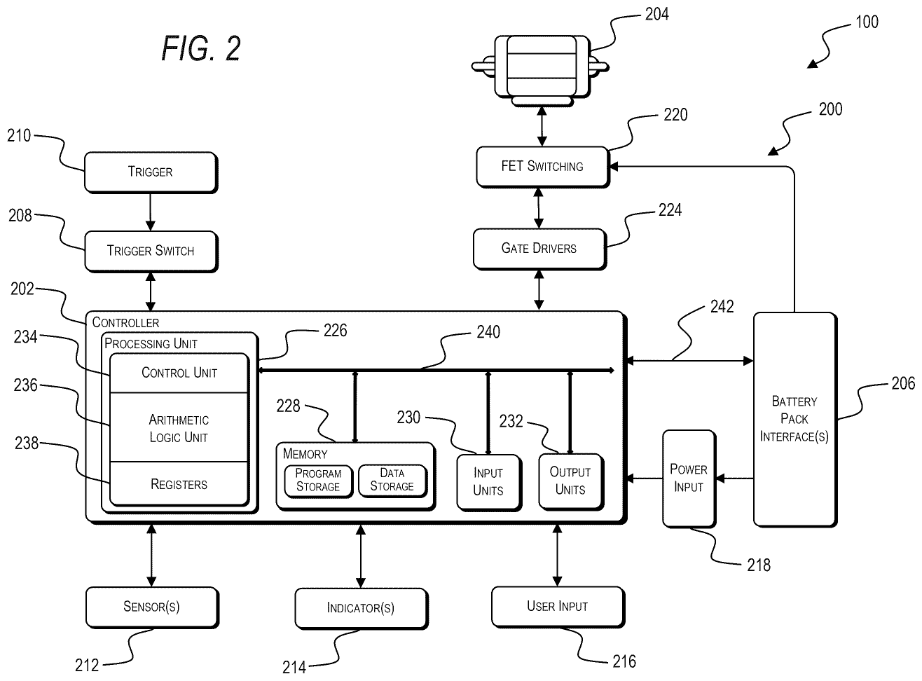

FIG. 2 illustrates a control system 200 for the power tool 100. The control system 200 includes a controller 202. The controller 202 is electrically and/or communicatively connected to a variety of modules or components of the power tool 100. For example, the illustrated controller 202 is electrically connected to a motor 204, a battery pack interface 206, a trigger switch 208 (connected to a trigger 210), one or more sensing circuits or sensors 212, one or more indicators 214, a user input module 216, a power input module 218, an inverter bridge or FET switching module 220 (e.g., including a plurality of switching FETs), and gate drivers 224 for driving the FET switching module 220. The controller 202 includes combinations of hardware and software that are operable to, among other things, control the operation of the power tool 100, monitor the operation of the power tool 100, activate the one or more indicators 214 (e.g., an LED), etc.

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the disclosure provided herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 202. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

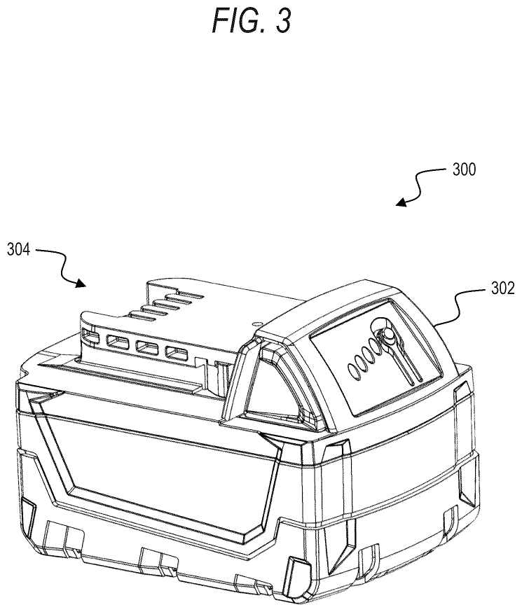

The battery pack interface 206 includes a combination of mechanical components (e.g., rails, grooves, latches, etc.) and electrical components (e.g., one or more terminals) configured to and operable for interfacing (e.g., mechanically, electrically, and communicatively connecting) with a battery pack. For example, power provided by a battery pack 300 (see FIG. 3) to the power tool 100 is provided through the battery pack interface 206 to the power input module 218. The power input module 218 includes combinations of active and passive components to regulate or control the power received from the battery pack 300 prior to power being provided to the controller 202. The battery pack interface 206 also supplies power to the FET switching module 220 to be switched by the switching FETs to selectively provide power to the motor 204. The battery pack interface 206 also includes, for example, a communication line 242 for providing a communication line or link between the controller 202 and the battery pack 300.

The sensors 212 include one or more current sensors, one or more speed sensors, one or more Hall effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status the motor 204, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

FIG. 3 illustrates a battery pack 300. The battery pack 300 includes a housing 302 and an interface portion 304 for connecting the battery pack 300 to a power tool, such as the power tool 100.

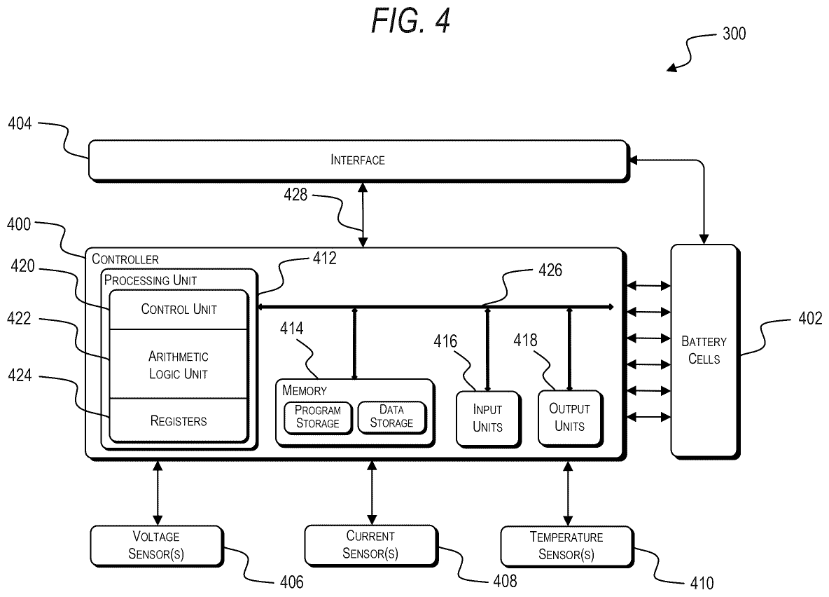

FIG. 4 illustrates a control system for the battery pack 300. The control system includes a controller 400. The controller 400 is electrically and/or communicatively connected to a variety of modules or components of the battery pack 300. For example, the illustrated controller 400 is connected to one or more battery cells 402 and an interface 404 (e.g., the interface portion 304 of the battery pack 300 illustrated in FIG. 3). The controller 400 is also connected to one or more voltage sensors or voltage sensing circuits 406, one or more current sensors or current sensing circuits 408, and one or more temperature sensors or temperature sensing circuits 410. The controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The controller 400 includes a plurality of electrical and electronic components that provide power, operational control, and protection to the components and modules within the controller 400 and/or the battery pack 300. For example, the controller 400 includes, among other things, a processing unit 412 (e.g., a microprocessor, a microcontroller, an electronic processor, an electronic controller, or another suitable programmable device), a memory 414, input units 416, and output units 418. The processing unit 412 includes, among other things, a control unit 420, an ALU 422, and a plurality of registers 424, and is implemented using a known computer architecture (e.g., a modified Harvard architecture, a von Neumann architecture, etc.). The processing unit 412, the memory 414, the input units 416, and the output units 418, as well as the various modules or circuits connected to the controller 400 are connected by one or more control and/or data buses (e.g., common bus 426). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 414 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 412 is connected to the memory 414 and executes software instructions that are capable of being stored in a RAM of the memory 414 (e.g., during execution), a ROM of the memory 414 (e.g., on a generally permanent basis), or another non-transitory computer readable medium such as another memory or a disc. Software included in the implementation of the battery pack 300 can be stored in the memory 414 of the controller 400. The software includes, for example, firmware, one or more applications, program data, filters, rules, one or more program modules, and other executable instructions. The controller 400 is configured to retrieve from the memory 414 and execute, among other things, instructions related to the control processes and methods described herein. In other constructions, the controller 400 includes additional, fewer, or different components.

The interface 404 includes a combination of mechanical components (e.g., rails, grooves, latches, etc.) and electrical components (e.g., one or more terminals) configured to and operable for interfacing (e.g., mechanically, electrically, and communicatively connecting) the battery pack 300 with another device (e.g., the power tool 100, a battery pack charger, etc.). For example, the interface 404 is configured to communicatively connect to the controller 400 via a communications line 428.

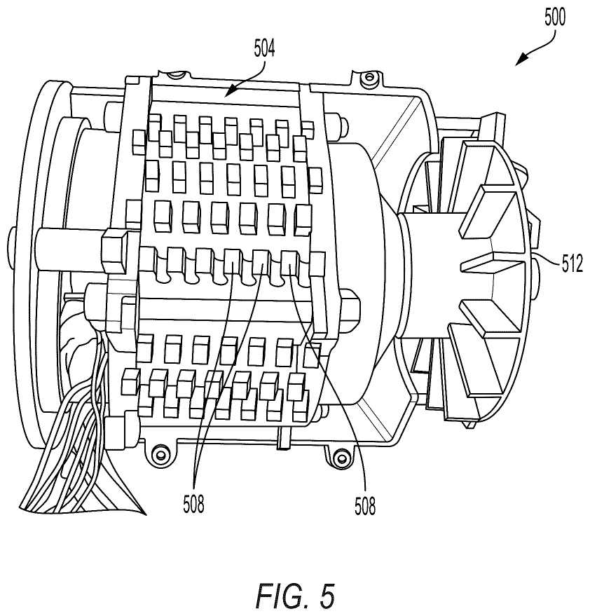

FIG. 5 illustrates a motor 500, according to some embodiments. The motor 500 includes a laminated stator 504 with a plurality of fins 508, and a fan 512. The fan 512 is coupled to a rotor of the motor 500. In some embodiments, the motor 500 is an inner-rotor motor. In other embodiments, the motor 500 is an outer rotor motor. In the illustrated embodiment, the laminated stator 504 is formed of a plurality of laminations having different profiles. In other embodiments, each of the plurality of laminations may share the same profile. The plurality of fins 508 is positioned circumferentially about the laminated stator 504 and is configured to increase the surface area of the laminated stator 504 for improved heat dissipation. The fan 512 is configured draw in air from the surroundings and move air along the laminated stator 504 and the fins 508 to cool the motor 500.

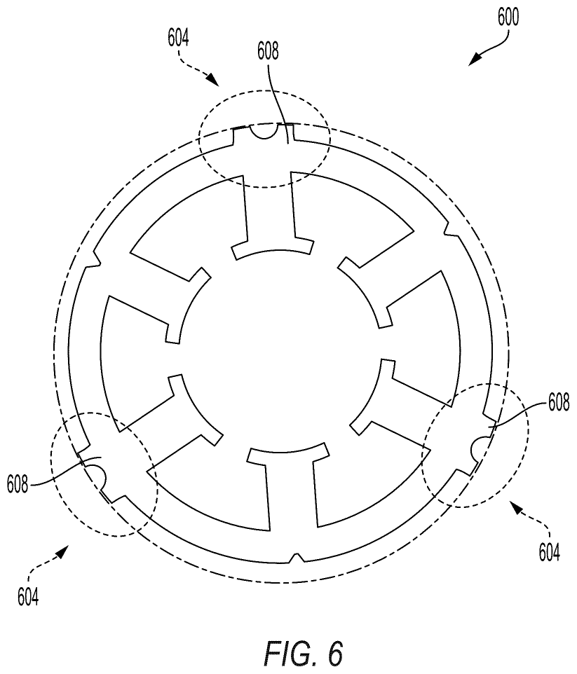

FIG. 6 illustrates a top view of a stator lamination 600 for a motor (e.g., motor 204, 500). The stator lamination 600 is combined with a plurality of other stator laminations to form a stator lamination stack (e.g., laminated stator 504). The stator lamination 600 includes a plurality of finned regions 604 that each include one or more fins 608. The fins 608 extend outwardly (e.g., radially outwardly) from the remainder (e.g., an outer surface) of the stator lamination 600 (e.g., a center of the stator lamination) and are positioned circumferentially about the stator lamination 600. In the illustrated embodiment, each fin 608 is spaced approximately 120° apart from one another. However, in other embodiments each fin 608 may be spaced further apart, closer together, and/or non-uniformly. Additionally, in some embodiments, more than the illustrated six fins 608 can be included in the stator lamination 600. In some embodiments, the stator lamination includes four or more fins 608. The fins 608 are configured to increase the surface area of the stator lamination 600 to promote increased heat transfer to the surroundings. With an increased heat transfer ability, the motor (e.g., motor 204) of the power tool 100 will be able to operate at a higher power and/or operate for a longer period of time under load. A plurality of the stator laminations 600 can be combined to form a laminated stator that can, for example, be used in conjunction with the fan 512.

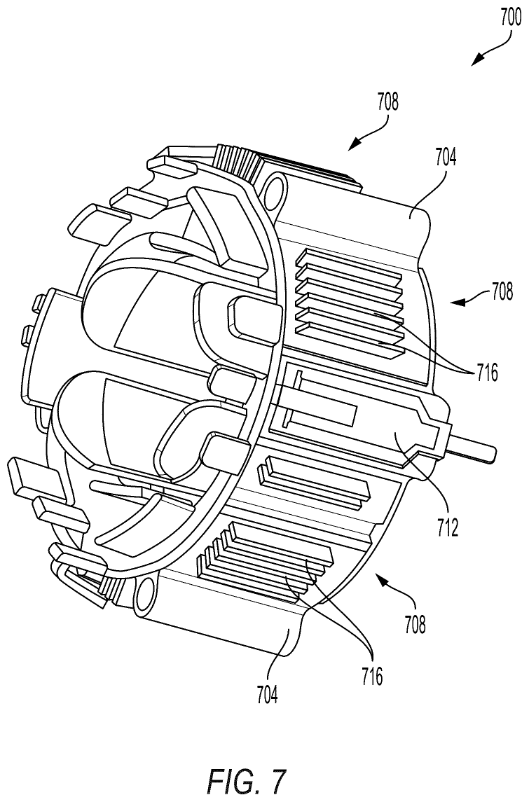

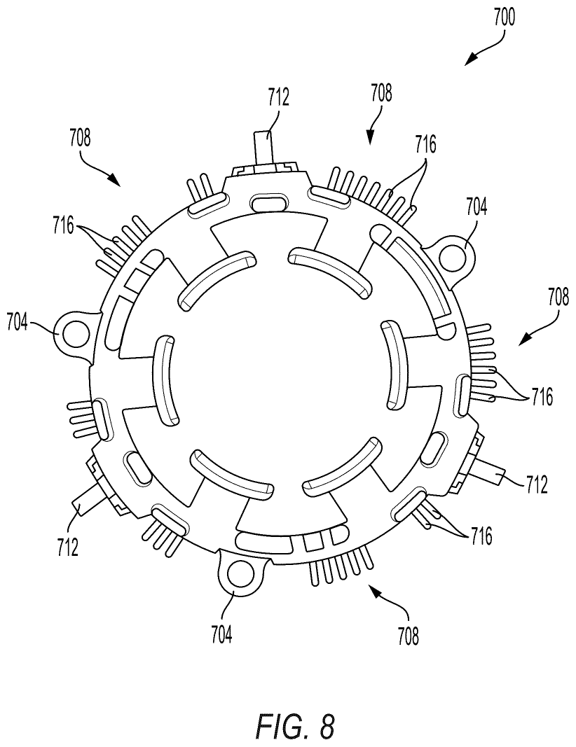

FIGS. 7-8 illustrate another embodiment of a laminated stator 700 of a motor (e.g., motor 204, 500). The laminated stator 700 includes a plurality of mounting features 704, a plurality of finned regions 708, and a plurality of power terminals 712. The mounting features 704 extend outwardly and are spaced circumferentially apart from each other around the laminated stator 700. The mounting features 704 are configured to receive, for example, fasteners (e.g., screws) to couple the laminated stator 700 to a motor housing or another structure of the power tool 100. The plurality of finned regions 708 are spaced circumferentially from each other around a circumference of the laminated stator 700 and to conduct heat from the stator windings. Each finned region 708 also includes a plurality of fins 716 extending outwardly (e.g., radially outwardly from an outer surface of the laminated stator 700). In the illustrated embodiment, the number of fins 716 per finned region 708 is variable between 2 and 7. In other embodiments, the finned regions 708 may include greater or fewer fins 716 or may include the same (equal) number of fins 716 in each finned region 708. The fins 716 are configured to increase the surface area of the stator 700 for improved heat dissipation for the stator 700 and the stator windings. Heat dissipation is further improved through airflow passing over the fins 716 (e.g., from airflow from fan 512).

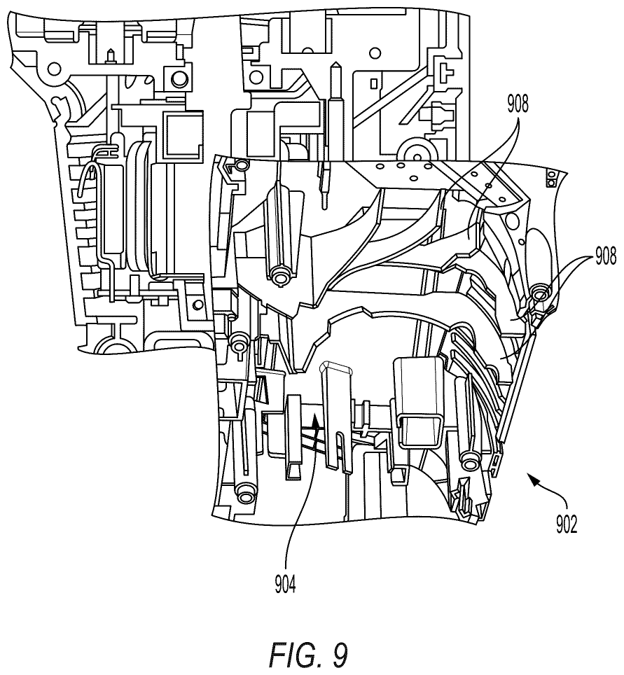

FIG. 9 illustrates an internal view of a power tool housing 902 (e.g., of power tool 100). The power tool housing 902 includes a motor receiving region 904 and a plurality of ribs 908. The motor receiving region 904 is shaped to receive a motor (e.g., motor 204, 500) of the power tool 100. The plurality of ribs 908 restrict air around the stator and prevent recirculation of hot air within the power tool 100. The plurality of ribs 908 instead act as a baffle and direct airflow around a stator (e.g., stator 700) of the motor and out of the power tool 100.

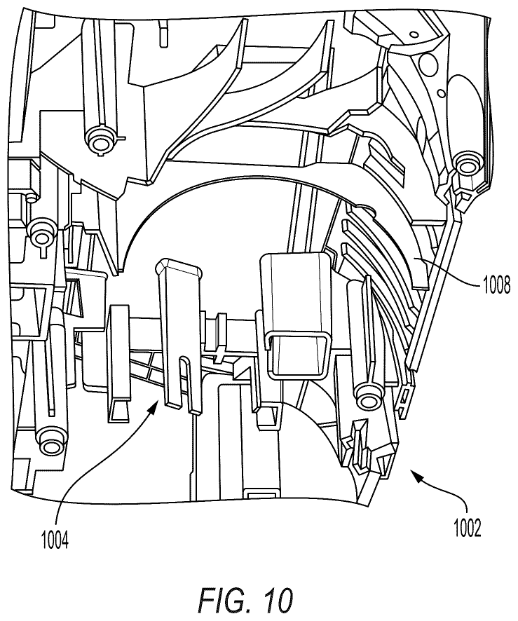

FIG. 10 illustrates an internal view of a power tool housing 1002 (e.g., of power tool 100). The power tool housing 1002 includes a motor receiving region 1004 and a rib 1008 (e.g., a single rib). The motor receiving region 1004 is shaped to receive a motor (e.g., motor 204, 500) with a finned stator (e.g., 700). The rib 1008 includes clearances for the finned stator and is still configured to restrict a significant portion of the airflow outside of the finned stator.

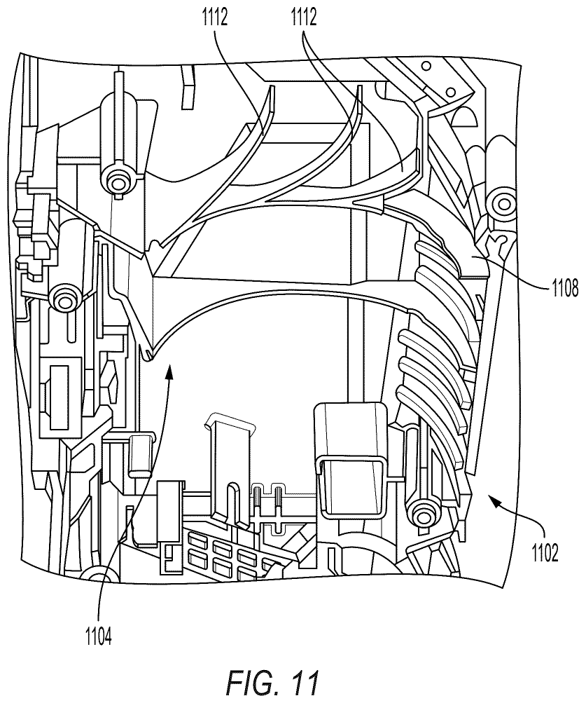

FIG. 11 illustrates an internal view of a power tool housing 1102 (e.g., of power tool 100). The power tool housing 1102 includes a motor receiving region 1104, a first rib 1108 (e.g., a single rib), and a plurality of second ribs 1112. The motor receiving region 1104 is shaped to receive a motor (e.g., motor 204, 500) with a finned stator (e.g., stator 700). The first rib 1108 is configured to restrict airflow outside of the finned stator. The second ribs 1112 act as a baffle and allow additional airflow around the outside of the finned stator. Compared to the ribs 908, the second ribs 1112 are thinner and can be tapered from one end to the other to reduce the obstruction of airflow.

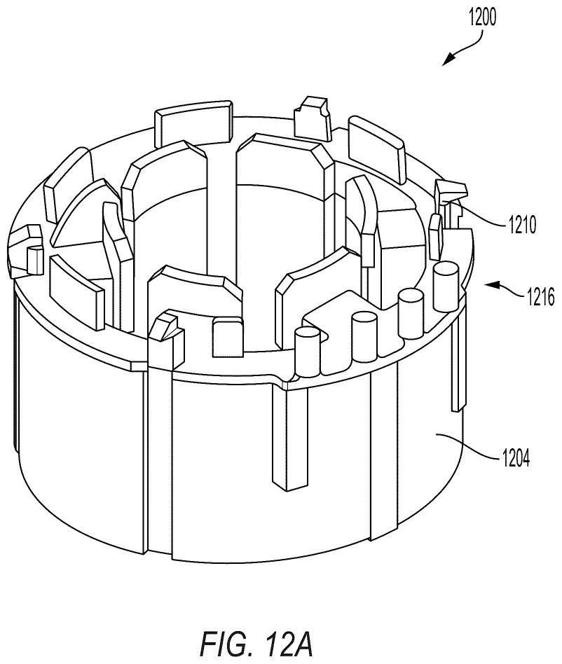

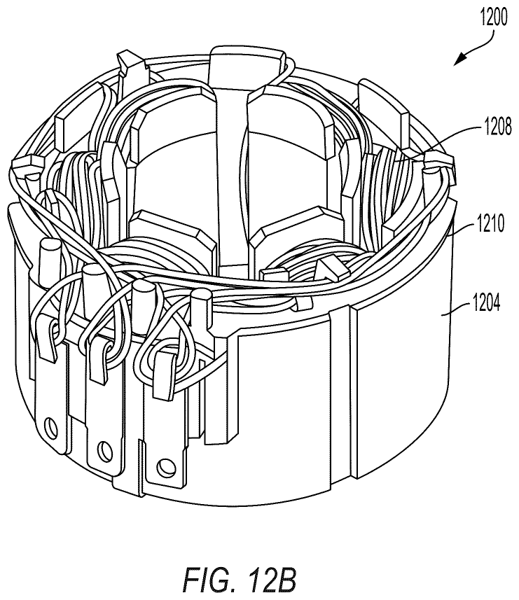

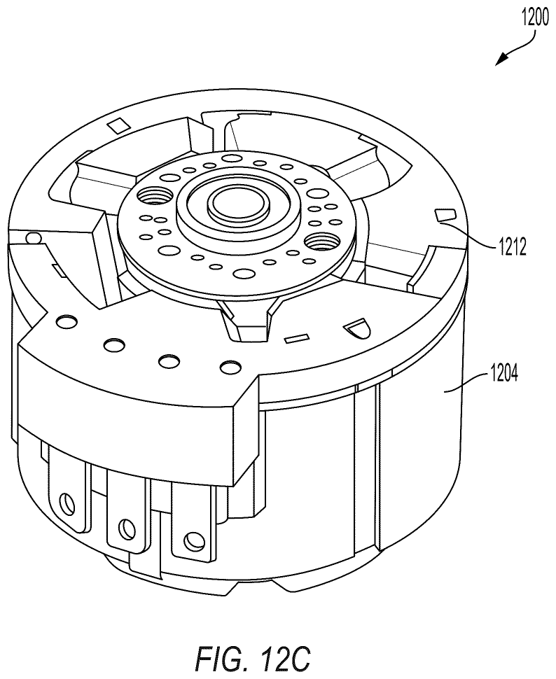

FIG. 12A-12C illustrate a stator 1200. The stator 1200 includes a stator lamination stack 1204, a plurality of stator windings 1208 (see FIG. 12B), an end cap 1210 (e.g., ground insulation for the stator 1200), and an insulation portion 1212 (see FIG. 12C; e.g., an over-coil encapsulation for the stator 1200). As shown in FIG. 12A, the end cap 1210 is positioned on a first end 1216 of the stator 1204. In some embodiments, the stator 1200 includes a single end cap 1210 that extends to both sides of the stator 1200. In other embodiments, each end of the stator 1200 includes a separate end cap 1210. The end cap 1210 forms a plurality of stator teeth around which the plurality of stator winding 1208 are wound (see FIG. 12B). The end cap 1210 is formed of a thermally conductive but electrically insulative material.

In some embodiments, the end cap 1210 is formed or made of a first material having various potential values for thermal conductivity or a second material having various potential values for thermal conductivity. In some embodiments, the first material includes an insulation made with up to 50% glass-filled nylon, and the first material has no thermal conductivity or a low thermal conductivity (e.g., less than 1 Watt per meter-kelvin [“W/mK”] in-plane thermal conductivity). In some embodiments, the second material includes an insulation made of, for example, polyamide 46 (or nylon 46), and has a low thermal conductivity, a medium thermal conductivity, or a high thermal conductivity. A low thermal conductivity corresponds to an in-plane thermal conductivity of, for example, 1.4 W/mK or less and a through-plane thermal conductivity of, for example, 0.7 W/mK. A medium thermal conductivity corresponds to an in-plane thermal conductivity of, for example, 1.41 W/mK to 1.99 W/mK and a through-plane thermal conductivity of, for example, 1.4 W/mK. A high thermal conductivity corresponds to an in-plane thermal conductivity of, for example, 2.0 W/mK or more and a through-plane thermal conductivity of, for example, 0.9 W/mK.

As shown in FIG. 12C, the insulative portion 1212 is formed over the stator windings 1208 and the end cap 1210 and encapsulate the stator windings 1208 and end cap 1210. The encapsulation of the stator windings 1208 provide protection from excess vibration or foreign material (e.g., dirt, dust, metal shavings, concrete particles, etc.) from entering the stator 1200. The insulative portion 1212 is made of a thermally conductive but electrically insulative material and is formed on the stator 1200 by, for example, an over-molding process. In some embodiments, the insulative portion is formed on the stator 1204 through potting. The thermal conductivity of the insulative portion 1212 allows for greater heat dissipation from the stator windings 1208, which provides increased thermal headroom for the motor to operate at a higher power and/or for a longer duration under load.

In some embodiments, the insulative portion 1212 is formed or made of a first material (e.g., plastic, nylon, etc.) having various potential values for thermal conductivity. In some embodiments, the first material includes an insulation made of, for example, polyamide 46 (or nylon 46) and the thermal conductivity of the first material can be tuned to a desired value. For example, the thermal conductivity of the insulative portion 1212 can have a low thermal conductivity, a medium thermal conductivity, or a high thermal conductivity. A low thermal conductivity corresponds to an in-plane thermal conductivity of, for example, 1.4 W/mK or less and a through-plane thermal conductivity of, for example, 0.7 W/mK. In-plane thermal conductivity refers to a measurement of heat transfer within a plane of the material. Through-plane thermal conductivity refers to a measurement of heat transfer through a thickness of the material. A medium thermal conductivity corresponds to an in-plane thermal conductivity of, for example, 1.41 W/mK to 1.99 W/mK and a through-plane thermal conductivity of, for example, 1.4 W/mK. A high thermal conductivity corresponds to an in-plane thermal conductivity of, for example, 2.0 W/mK or more and a through-plane thermal conductivity of, for example, 0.9 W/mK.

In various embodiments, either the first material or the second material of the end cap 1210 can be paired with the material of the insulative portion 1212 having any of the low thermal conductivity, the medium thermal conductivity, or the high thermal conductivity. Based on the selected materials, different levels of thermal performance can be achieved for the stator 1200. For example, manufacturing the stator 1200 of materials having high thermal conductivities can lead to a longer operational life for the stator 1200 because potential damage to the stator that can occur over the course of the operational life of the stator 1200 is reduced.

Thus, embodiments described herein provide, among other things, power tool motors including heat dissipating features. Various features and advantages are set forth in the following claims.

What is claimed is:

1. A power tool comprising:
a housing; and
a motor assembly positioned within the housing, the motor assembly including:
a rotor, and
a stator including:
a plurality of stator windings,
an end cap, and
an insulative portion,
wherein the insulative portion has an in-plane thermal conductivity of at least 2.0 Watts per meter-kelvin (“W/mK”).

2. The power tool of claim 1, wherein the insulative portion is made of polyamide 46.

3. The power tool of claim 1, wherein the end cap is made of polyamide 46.

4. The power tool of claim 1, further comprising:
a second end cap.

5. The power tool of claim 4, wherein the second end cap is made of polyamide 46.

6. A power tool comprising:
a housing; and
a motor assembly positioned within the housing, the motor assembly including:
a rotor, and
a stator including:
a plurality of stator windings, and
a stator lamination including at least one fin extending radially outwardly from a center of the stator lamination.

7. The power tool of claim 6, wherein the stator lamination includes at least three fins extending radially outwardly from the center of the stator lamination.

8. The power tool of claim 7, wherein each of the at least three fins are spaced apart from one another by approximately 120° around a surface of the stator lamination.

9. The power tool of claim 6, further comprising:
a motor receiving region including a plurality of ribs.

10. The power tool of claim 9, wherein each of the plurality of ribs is tapered from one end to another to reduce an obstruction of airflow.

11. The power tool of claim 6, wherein the stator includes a plurality of stator laminations including at least one fin extending radially outwardly from the center of the stator lamination.

12. The power tool of claim 6, wherein the motor assembly further includes a fan.

13. The power tool of claim 12, wherein the fan is configured to move air along the stator and the at least one fin.

14. The power tool of claim 6, wherein the stator lamination includes four or more fins extending radially outwardly from the center of the stator lamination.

15. A power tool comprising:
a housing; and
a motor assembly positioned within the housing, the motor assembly including:
a rotor, and
a stator including a plurality of finned regions spaced circumferentially from each other around a circumference of the stator, each finned region including a plurality of fins extending radially outwardly from an outer surface of the stator.

16. The power tool of claim 15, wherein each of the plurality of finned regions includes 2-7 fins.

17. The power tool of claim 15, wherein the stator further includes a plurality of mounting features extending outwardly from the outer surface of the stator.

18. The power tool of claim 17, wherein the plurality of mounting features are spaced circumferentially apart from each other around the circumference of the stator.

19. The power tool of claim 15, wherein each finned region includes an equal number of fins.

20. The power tool of claim 15, wherein the plurality of finned regions include different numbers of fins.
